(19) United States
(12) Patent Application Publication
(10) Pub. No.: US 2019/0234748 A1
(43) Pub. Date: Aug. 1, 2019

(54) MANAGEMENT OF GROUP AND NAVIGATION INFORMATION FOR TRAVELERS

(71) Applicant: WOLFPACK, Rockville, MD (US)

(72) Inventor: Jonathan CHASHPER, Rockville, MD (US)

(73) Assignee: WOLFPACK, Rockville, MD (US)

(21) Appl. No.: 16/261,735

(22) Filed: Jan. 30, 2019

Related U.S. Application Data
(60) Provisional application No. 62/624,347, filed on Jan. 31, 2018.

(51) Int. Cl. G01C 21/34; G01C 21/36

(52) U.S. Cl. CPC G01C 21/3438; G01C 21/3626; G01C 21/367; G01C 21/3682

(57) ABSTRACT

An integrated experience for travelling in a group or pack whereby a user can invite fellow users to join their group, organize a group trip (run) at a specified time and date, and experience an on-trip navigation interface that provides real-time updates on group member position and basic communications. Trip information is collected and made accessible to anyone interested in exploring new routes. A user may organize groups and plan routes for group travel. An interface simplifies communicate with fellow group members and a geofence notifies group members if they have strayed away from the group. The interface further includes navigation, group communications, sending a predefined message to group members (as easy as taps of a finger), group positioning (i.e., visualize the location of each traveler), group management, run management (i.e., plan and schedule routes), and a contact management and invitation system.

### TECHNICAL FIELD

The present invention relates to systems and methods for managing group travel, navigation and event information and communication.

### BACKGROUND

Group travel, such as motorcycle riding, bicycle riding, hiking or car group travel, has become popular and people from different backgrounds have become more and more involved in group travel activities. This increase in group travel has resulted in an increase in the need for travelers to plan and communicate regarding present and future trips. However, it may be difficult to find friends to travel with and, therefore, the traveler is not able to take advantage of the vast network of traveling enthusiasts and viable travel locations. For example, conventional trip planning systems do not take into account the need to add additional traveler after a trip has started.

Additionally, the ability to communicate with other travelers in one's group is often cumbersome and can be dangerous if undertake while moving. For example, riders in motorcycle groups have difficulty communicating during a ride and often are forced to resort to hand signals. When one rider wishes, for example, to stop for fuel, the rider may resort to pulling to the head of the group to use hand signals to communicate the rider's intentions. These actions can be dangerous to the rider, the group and the public in general.

Conventional systems also lack the ability to track the relative location of each members of the group during the travel event.

### SUMMARY OF THE INVENTION

A computer-implemented method and system is provided for performing group navigation and planning for a user. A computer interface is constructed and arranged to receive travel criteria inputs from the user and to display human-centric navigation information to the user. The user creates, by the computer interface, a planned travel route including a start time, a starting location and an end location. The computer interface also allows the user to create a more elaborate travel plan through the use of way-points (way-points are points on the planned route through which the planner wants to go through). The computer displays the planned travel route. A user may invite additional users to join in a traveling event along the planned travel route, whereby the invitation includes receiving any number of additional users after said start time, the additional users being able to join the traveling event after other users have embarked upon the traveling event. Communicating between at least one user and the additional users is possible during the traveling event. The computer stores data related to the traveling event for future access by the at least one user and the additional users.

Significant to the present invention is the ability for all users (i.e., the group) to view the navigation and direction details for the group as well as individual users in the group through the user interface.

Additionally, the computer displays a user location window or “radar window” showing a geographic location of the original user and the additional users (the group) relative to each other to indicate a range of separation between each user in the group. In this regard, the computer additionally may display a zoomed view or “big radar” window showing the actual geographic location of the user and the additional users (the group) on a moving map. Each user in this display is identifiable through the use of graphical and text indications. Such location indicators are positioned on the map at the current location of the user. The computer updates locations automatically. The term “radar” is not used in the conventional sense and it is not intended to limit the nature and scope of the geographic display and geo-fence features provided by the present invention.

Additionally, the invention provides for sending, during the travel event, a user-defined preset message, in any language, about any topic, simultaneously to all users actively traveling together on the trip. This feature allows for pre-set message customizable to a particular traveler and/or group so that a traveler may efficiently send a specific message to co-travelers.

This brief description is provided to introduce a selection of concepts in a simplified form as compared to that described below in the detailed description. This brief description is not intended to be an extensive overview of the claimed subject matter, identify key factors or essential features of the claimed subject matter, nor is it intended to be used to limit the scope of the claimed subject matter.

The following description and annexed drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings in which:

FIG. 1 illustrates a computer hardware environment according to an embodiment of the present invention;

FIG. 2 illustrates an example of a non-limiting organic grouping system that may be utilized with various modes of navigation and route sharing according to an aspect of this disclosure;

FIG. 3 illustrates an exemplary data input system for creating a new kind of trip open to a closed group or open to the public according to an aspect of this disclosure;

FIG. 3a illustrates an alternate interface for showing planned trips and for accessing the interface of FIG. 3 for inputting and creating a trip as described with respect to FIG. 3;

FIG. 4 illustrates an exemplary data input system for choosing a solo run, a public run or a run associated with specific pack previously created in the system according to an aspect of this disclosure;

FIG. 5 illustrates an exemplary data input system for choosing from a previously stored set of public runs recorded by the system according to an aspect of this disclosure;

FIG. 6 illustrates an exemplary embodiment for selecting a previous run or travel route from a previously stored set of recommended runs stored by the system according to an aspect of this disclosure, once selected, a user can “re-travel” the same route, at any time, or even, make changes to create a new route based on the one that was selected;

FIG. 6a illustrates an enlarged map view of path of travel related to one of the recommended runs stored in the system according to an embodiment of the present invention.

FIG. 7 illustrates an exemplary non-limiting embodiment for selecting a travel route or run from a previously stored set of runs stored in a library of the system according to an aspect of this disclosure;

FIG. 8 illustrates an exemplary, non-limiting, embodiment for creating new runs or selecting runs from a log book;

FIG. 9 illustrates an exemplary, non-limiting, embodiment for displaying a route of travel for a group whereby every rider in the pack sees the position of other riders in a radar window and allowing the rider to keep formation and position within the pack, thus keeping the pack together according to an aspect of the instant disclosure;

FIG. 9a illustrates an exemplary, non-limiting, embodiment for displaying a route of travel for a group whereby every rider in the pack sees the position of other riders in a big radar window which is a detailed view showing specific user location with a moving geofence and turn-by-turn navigation capabilities according to an embodiment of the present invention.

FIG. 10 illustrates an exemplary, non-limiting computing environment where one or more users may view a route of travel on a map with points of interest and waypoints are displayed in a convenient manner according to an aspect of this disclosure are implemented;

FIGS. 11a and 11b illustrate an exemplary, non-limiting, embodiment of the system which provides a group broadcast messaging solution that allows pack members to communicate while on the ride through a use of pre-canned messages;

FIG. 12 illustrates a more specific exemplary embodiment of the system of the present invention including basic components including CloudFront which is a web service for content delivery that makes it easier to distribute content to end users quickly, with low latency and high data transfer speeds as well as other network component according to an embodiment of the present invention.

FIG. 13 illustrates an exemplary non-limiting embodiment of the invention for providing rental information to a group member and linked to a specific run of a user of group of users according to an aspect of the present invention;

FIG. 14 illustrates an exemplary non-limiting method according to the present invention

FIG. 15 illustrates a listing of previously created packs with an invitation to create new packs in accordance with an embodiment of the present invention;

FIG. 16 illustrates a listing of previous experience by a particular user with specific data about historical runs associated with that user and or pack.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

The present invention is, preferably but not limited to, a system accessed through a mobile device that provides an integrated experience for travelling in a group or pack which provides group navigation and direction data to each individual user during the travel event. A user can invite fellow travelers to join their group, organize a group run at a specified time and date, and experience an on-trip navigation interface that provides real-time updates on traveler position, navigation and basic communications including direction data and details. While providing this experience to the user, the present inventive system collects trip information and makes it accessible to anyone interested in exploring new routes.

For example, motorcycle riders may like to ride in groups, which may be based on the belief that there is safety in numbers or may result from the camaraderie of motorcycle enthusiasts. Certainly, more riders may make the group more visible to others on the road. However, at times it may be difficult to find someone to ride with and, therefore, a rider may ride alone. The various aspects disclosed herein allow two or more riders (or operators of other vehicles) to group with each other for at least a portion of a route so that the users may share navigation and direction details as well as other communication information relevant to the group. Other vehicles that may utilize the disclosed aspects include, but are not limited to, bicycles, various off-road vehicles, automobiles (e.g., driving highway 50 across Nevada), boats, planes, and so on. The instant disclosure may also apply to groups travelling on foot (e.g., hikers, tourists, etc.) or other means of travel.

The present invention may run on iOS and Android and allows the user the ability to quickly enhance their group traveling experience. From their account, the user is able to organize their own groups and plan out “runs”—routes for group travel. The invention integrates a navigation interface with improvements: the ability to simply communicate with fellow group travelers and a moving geofence that permits users to view the relative position of users within the group, centered around their location and notifies users if one or more users have strayed away from the group, outside of the permitted limits of the moving geofence.

In accord with a preferred embodiment, the present invention is directed to motorcyclists travelling in groups of three or more, typically riding cruisers, adventure bikes or touring bikes. Group riding is a common practice—whether riding for leisure, group commutes, or simply to get from here to there. Outside of the specific application of motorcycle enthusiasts, the present invention is equally applicable to other groups of travelers (e.g., tour groups, bicyclists and hikers are examples).

Communicating and coordinating a group while travelling to the same destination is challenging. To date, it is not possible to view group navigation and direction details in a single interface. Conventional travel systems provide navigation details for individuals—but not for a group. The present invention focuses on three key problems: group navigation, communicating and staying together as a group. By way of example, this application will focus on the travel patterns of motorcycle enthusiasts; however, this exemplary description is not intended to limit the application of the present invention. Yet the motorcycle as well as other group travel experiences experience present unique challenges. Between noise, distance between riders, road hazards, and the need to stay focused, traveling in a group and, in particular, riding a motorcycle makes one-to-one communication challenging and one-to-many communication close to impossible. Riders often resort to hand gestures or even passing other motorists in order to yell instructions. When riding in a group, riders often get disconnected, lost, or just separated, potentially resulting in reckless driving as they try to reconnect with the group.

Some components of the inventive system include: navigation, group communications: sending a predefined message to group riders is as easy as two taps of the finger, group positioning (i.e., visualize the location of riders in your group at a glance), radar (i.e., keep up with your group with radar showing group positioning), group management (i.e., create groups of friends who want to travel together), run management (i.e., plan and schedule routes for you and your pack), and an integrated contact management and invitation system.

An implementation of this disclosure relates to an organic gathering system for route planning and sharing. The system includes a profile manager determining settings associated with a group leader who creates a group of travelers and plans a trip. The system also includes a community of travelers who may share their experiences and observations in a defined geographic area. Further, the system includes a navigation manager providing instructions to the group and/or pack of riders related to the community. The system provides for private group trip and public group trips as well as access to a library of recommend runs and a library of popular runs. Users may also view a library of their travel history alone and in groups.

Another implementation of this disclosure relates to a method for grouping two or more users for travel together. The method includes determining, by a system comprising a processor, a group of users traveling within a geographic area of a first user. The method also includes evaluating, by the system, respective profile data of each user in the group of users based on profile data of the first user. Further, the method includes outputting, by the system, details related to other users of the group of users as a result of the evaluating. The method also includes providing, by the system, instructions for grouping the leader with the other users. The instructions include details related to waiting at a designated location until the second user arrives at the designated location; e.g., a gas station or a rest area.

A pack (a/k/a “wolfpack”) is a group of friends who want to travel together. Each user may have as many packs with any number of friends in each. When a pack is ready (whether it is a pack of 2 or 10), it can be invited on a run (a run is a trip/route on which the pack wants to go), once invited, each member will immediately receive the run plan, starting point, start time, etc. Any changes made to the run will immediately be updated for every member of the pack. A rider may invite users by e-mail, through Facebook, Twitter, and other social media sites, and through SMS messaging. Any rider may create a run specifying: (1) start date/time, end date/time, starting (meeting) point, and destination. Way points can be added to the run by users, allowing for a better planning experience and a more enjoyable run. Riders can also choose to avoid highways, tolls and ferries. Once a run is created, preferably it is immediately available to all pack members. Pack members can enjoy the way-points once created by a user.

The system according to an embodiment of the invention may provide the ability to build and maintain a list of other users who are “friends.” A friend in this list does not need to be a member of a user's active groups/packs. The system allows a friend to be easily added to new packs the user chooses to create. Friends are added in one of two ways: (1) automatically when a user is part of a pack the user joins) and (2) through an invite system.

Additionally, the system may include a feature to send and/or accept invitations between users to join each other's friends lists. This feature is turned off by default and can be enabled by the user in his settings screen. When turned on, the user is prompted to select the city they wish to be associated with. Users with the feature enabled to conduct a search for other users based on geography or other relevant features. For example, choosing a city returns the list of users with (a) the feature enabled and (b) that search city associated with their account. The system may automatically show indications for each user in the search results (a) if the user is already a friend, (b) if an invite is pending to that user, or (c) if the user can be sent an invite. In the first two scenarios, an invite will not be sent. To send an invite, the system allows the user to write a customized welcome message and send the invitation. The ability to send and accept friend invites is available in unlimited form for premium users and with some limitations for some users.

Users may have access to a chat system within each group. Through the chat, travelers can send messages, communicate about past and future rides, upload images etc. This feature adds another “social” component to making the group event even more enjoyable. Chat can only happen at “rest” when the group is not traveling.

The following section provides an example of an operating environment in which a method of managing event information for interested users can be embodied.

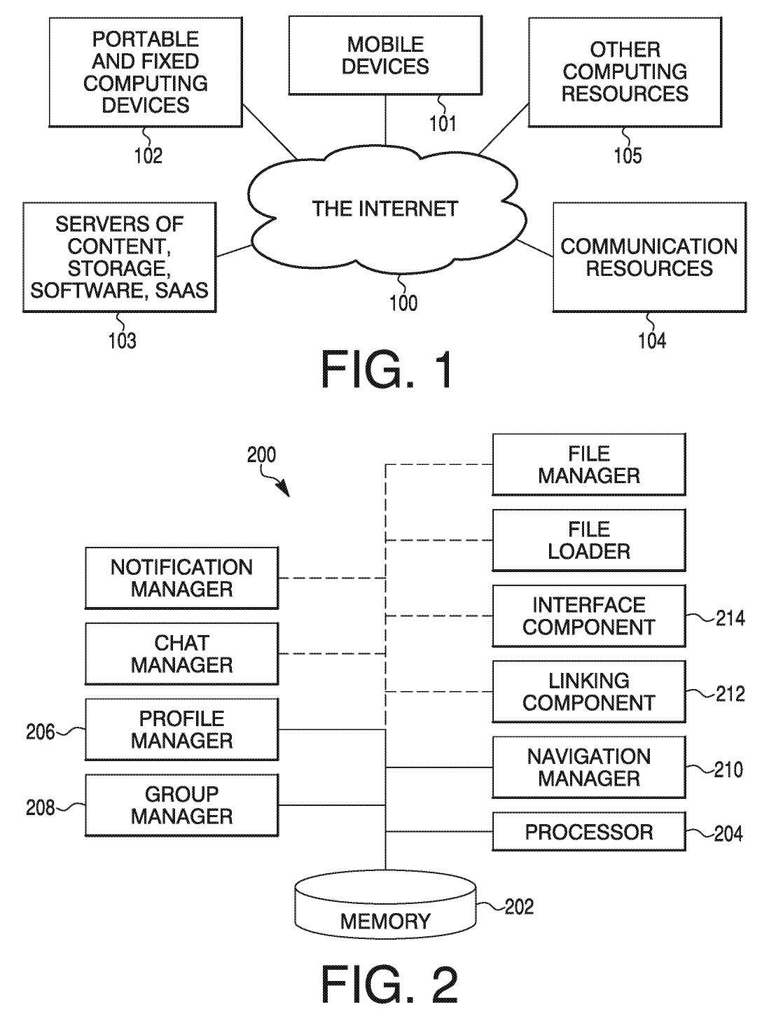

Referring to FIG. 1, a computer hardware environment in which the method can be practiced is described. The exemplary computer hardware environment can be generally described as a computer network of any suitable size and scope that supports and includes the operational elements and architecture relied on by the exemplary methods and apparatus described below. Some common operational elements and architectural features are now described in connection with FIG. 1.

Various computing devices are interconnected for communication through a computer network having any suitable hardware configuration, such as the global Internet computer network, 100. The computing devices can include one or more of any of the following devices: mobile devices, 101; portable and fixed computing devices, 102; servers, 103, of content, software, software as a service (SaaS), storage, and other resources; communication resources, 104, such as interconnects, switches, and routers; and other computing resources, 105. Mobile devices, portable and fixed computing devices, switches, routers, and servers generally include a central processing unit (CPU), microprocessor, micro-controller, or similar element that executes software instructions to accomplish the tasks for which they are employed. Local instructions and local data are stored in suitable forms of computer storage and computer memory, including both transitory and non-transitory media and/or signals. Devices may include input peripherals, display peripherals, and other peripherals that are either integrated into the device or connected to the device.

Given this context, an example implementation of the general operation of the method of managing event information for interested users will be described in more detail in connection with the appended drawings.

According to some embodiments of the invention, one or more server systems collect information about interest groups; user groups; and events related to individuals' interests, product ownership, and the like. Interest groups, user groups, sponsors, organizers, and the like, conventionally maintain lists of events (e.g., runs) that they organize or sponsor or that they consider might be of interest to their members. For example, an organization devoted to ownership of motorcycles may organize an enthusiast event, or a vehicle swap. A car club may organize rallies, shows, and equipment swaps. According to aspects of the present invention, all kinds of event information of interest to individuals based on event characteristics such as activity type, product type, date, time, and location are identified, collected, and captured, across different groups, sponsors, organizers, etc. Event information can alternatively be identified, collected, and captured, for example using conventional software tools for crawling, scraping, and cataloging event-related content stored and accessed through web servers connected to the internet. Event information can be identified, collected, and captured manually by information workers who seek relevant content. The cataloged, event-related content is loaded into a database accessible by users having access through the Internet to the database server, or accessible by users of web-enabled applications or mobile apps having access through the Internet to the database server. One primary focus of this invention is the organization of trips or runs by travel enthusiasts, wherein members of a group may join a group and travel an entire trip or may join the group mid-trip or mid-run.

A suite of mobile apps and/or SaaS web server tools can be provided to process the database to list or map all the events according to the users' preferences. Preferences can include activity type, interest area, date, time, location (including virtualized events taking place via the Internet), so the user can identify and network with people who are attending particular group run, planning on attending a particular event, or even en route to particular events.

Apps and web tools can preferably identify groups of events meeting user-specified criteria, identify groups of users travelling common routes or to common events so as to point out socialization opportunities, including at points of common interest to users along the route.

Having now described the general operation of aspects of the invention, a more specific example will now be described.

Mobile apps and web portals can be sponsored by or otherwise supported by any entity interested in supporting an activity type. These can be targeted to a trip, an event or type of event, but, in accordance with the invention, should not be tied to the event organizer or trip leader. Sponsors can support or sponsor the listing service rather than a particular event or event listing; however, the sponsorship can also be targeted to specific trips, events or event types.

Aspects of embodiments of the invention can be realized as a mobile app or computer/mobile device software designed to run on any networked computer tailored by or for organizations that have access to relevant data, users, advertisers, and/or a potential revenue stream that would take advantage of the novel social networking and other features of the invention.

Back-office software operating on or with access to the database server can gather data useful for promotional purposes through the system. Events are conventionally targeted at markets on seasonal, or cyclical, models based on demographic analyses of markets and regions. In contrast, back-office software according to aspects of embodiments of the invention can collect over a period of time, such as twelve months, events from a geographical area such as the US, for example, and create a colored map, in which colors or other visual variations applied to a geographical map signify concentrations of events across the region. Sequential colored maps can be produced for sequential points in time, across the region, showing the pattern over time of the events collected. By playing the sequential colored maps as an animation over the year, new promotional insights can be gained. For example, data can be filtered on various parameters, such as event type, such as user activities or sales activities to generate new insights regarding variations across regions and time intervals based on actual behavior of actual users, rather than the behavior of a presumed demographic. Tracking data can then be collected in the background as users search for, plan, and attend various online activities.

Mobile devices, and other suitable devices including geolocation services, are particularly useful to track trip participants and/or event attendees. Then, individuals can socialize with each other at the events they attend, or along the way to the events they attend, including at points of interest relevant to the activities of the event attendees. By tracking the search and travel plans of attendees, individuals can be introduced to others with common interests, common travel plans, and common attendance plans.

Several specific processes illustrating aspects of embodiments of the invention are now discussed in connection with FIGS. 2-11.

FIG. 2 illustrates an example of a non-limiting organic gathering system 200 that may be utilized with various modes of transportation according to an aspect of this disclosure. The organic gathering system 200 allows a motorcycle rider, for example, to determine if there are other riders in the area. If there are other riders, the organic gathering system 200 allows the rider to selectively connect with one or more of those other riders. For example, the riders may connect in order to travel together as a group.

Although the various aspects are discussed with respect to a motorcycle and a motorcycle rider, the aspects are not limited to this implementation. Instead, the aspects may be utilized by drivers and/or passengers of other modes of transportation including, but not limited to, vehicles (e.g., automobile, truck), bicycles, skateboards, pedestrians, joggers, drones, air vehicles, watercraft, and so on. In an example, the disclosed aspects may be utilized when the vehicle does not have a rider/user (e.g., a drone). For example, two or more drones may be delivering medical prescriptions to the same house, different houses on the same street, different houses in the same city, and so on. In this case, the drones may be grouped to facilitate at least a portion of the trip (or route) being shared by the two or more drones.

The gathering system 200 may include at least one memory 202 that may store computer executable components and/or computer executable instructions. The organic gathering system 200 may also include at least one processor 204, communicatively coupled to the at least one memory 202. The at least one processor 204 may facilitate execution of the computer executable components and/or the computer executable instructions stored in the memory 202. The term “coupled” or variants thereof may include various communications including, but not limited to, direct communications, indirect communications, wired communications, and/or wireless communications.

It is noted that although the one or more computer executable components and/or computer executable instructions may be illustrated and described herein as components and/or as instructions separate from the memory 202 (e.g., operatively connected to the memory 202), the various aspects are not limited to this implementation. Instead, in accordance with various implementations, the one or more computer executable components and/or the one or more computer executable instructions may be stored in (or integrated within) the memory 202. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

The organic gathering system 200 may include a profile manager 206 that determines settings associated with a first user or leader (e.g., the motorcycle rider). The settings may be determined based on input received from the first user and/or based on observed information. According to an implementation, the profile manager 206 may receive data manually input by the first user or leader, which may include preferences and other information. According to another implementation, the profile manager 206 may obtain the information based on historical information and/or current information related to the first user or leader as well as additional users.

The system 200 may also include a group manager 208 that determines a group of users (e.g., other motorcycle riders) in a defined geographic area. For example, the defined geographic area may be a configurable range or radius around the first user. According to some implementations, the defined area may be complex. For example, riders within a radius, and heading to destinations that are located within a radius of one another may constitute a group of users. In another example, riders moving in a same direction may constitute a group of users. Further, the group of users may be determined based on other similarities between the users.

Each user in the group of users may be those users that have opted into the system (e.g., agreed to participate in route sharing with other users). It is noted that in accordance with one or more implementations described in this disclosure, users may opt-out of providing personal information, demographic information, location information, proprietary information, sensitive information, or the like in connection with data gathering aspects. Moreover, one or more implementations described herein may provide for anonymizing collected, received, and/or transmitted data. Further, a user may opt-out of providing information at any time, regardless of whether the user previously opted-in to providing the information.

A navigation manager 210 may provide instructions to the first user related to the grouping. The navigation manager 210 may output the instructions in an audio format, a visual format, a haptic format, or combinations thereof. Thus, the navigation manager 210 may provide dynamic notifications related to other riders in the area and instructions on how to group up with the other riders. For example, the navigation manager 210 may notify the first user that there is another user up ahead and if the first user travels just a little faster, he/she will catch up with the other user. In another example, the navigation manager 210 may inform the first user to slow down or to stop at the next light (e.g., do not go through a yellow light) to allow another user to catch up to the first user. In a further example, the first user may be instructed to wait in a nearby parking lot for the other user. Additionally, the navigation manager 210 may instruct the first user to take a short detour in order to group with the other driver.

Further, the one or more other users (e.g., other motorcycle riders) with which the first user is being grouped may be given information about the first user. For example, the other users may be notified that the first user is waiting at the red light up ahead or that the first user has slowed down (and the others should speed up) to group with each other.

It should be noted that regardless of the action of the first rider, the second rider may be provided separate instructions. For example, a system associated with the second rider may act as if the second rider (discussed herein) is the first rider, and as if the first rider (discussed herein) is the second rider, without necessitating any change to the actions of the system 200 of the first rider. In a similar manner, each rider and their respective system may consider himself/herself to be the “first rider” or “leader” and the respective system (as well as the system 200) will still function appropriately.

According to some implementations, the navigation manager 210 may output a map that illustrates the relationship between the first user and the other users in the group of users. The relationship may include similarities between the first user and the other users (e.g., driving habits, driving behavior, intended route, and so on). Additionally or alternatively, the relationship may include group affiliation and/or filtering based on group affiliation before it reaches the point of being shown on a map. Further, the map may illustrate the current location of each of the riders to facilitate grouping.

In an implementation, after two or more riders are grouped, the system may continue to attempt to group those two or more riders with other riders. Thus, three or more riders may be grouped at different times. For example, a first and second rider are grouped and later those two riders are grouped with a third rider. A few minutes later, a fourth rider is grouped with the first three riders. Thereafter, the first rider turns off the road, away from the other three riders. This leaves the second rider, third rider, and fourth rider as a group. Other riders may join and/or one of the riders may leave the group. In such a manner, attempts are made to keep two or more riders together in a dynamic group. Alternatively or additionally, the group might be split. For example, a group of riders might separate with the first and second riders turning north and the third and fourth riders turning south.

FIG. 2 further illustrates an example non-limiting organic gathering system 200 for route sharing according to an aspect of this disclosure. As discussed herein, the various aspects allow users (e.g., riders, drivers, or others) to group through wireless communication network applications and/or connections while still allowing a first user (or subsequent users) to be flexible and leave the group as desired.

A linking component 212 may group the first user (e.g., motorcycle rider) with a second user (e.g., another motorcycle rider) based on respective riding habits (or habits associated with another mode of transportation). In an example, slower riders may be grouped with other slower riders, but would not be grouped with a rider that tends to ride at an excessive speed. For example, the profile manager 206 (or subsequent profile managers associated with other users) may gather information and determine settings associated with the first user. The settings may include information such as a safety rating of the first user, whether the first user habitually speeds or maintains the speed limit, and so on. According to an implementation, the profile manager 106 also gathers information related to the other users and maintains the settings for those other users (e.g., at a centralized server). However, according to some implementations, the settings are maintained by different profile managers associated with devices of each respective user and information communicated as necessary to group two or more users.

It is noted generally, that the application of this invention to motorcycles and riders has been presented as an exemplary embodiment for explanatory purposes only. This invention is suitable for a wide range of travelers as discussed herein. For example, this invention is particularly suited to all types of bike riders as well as hikers, bikers, automobile travelers, boaters, skiers, tourists, etc. The present invention should not be limited in any way to motorcyclists.

With respect to motorcyclists, although discussed with respect to riding habits, other parameters may be utilized additionally or alternatively. For example, a parameter may be a skill level, such as beginning, advanced, experienced, and so on. In another example, a parameter may be a bike style. Such styles may include sport, cruiser, touring, and so on. In yet another example, a parameter may be a displacement. For example, the displacement may be 250 cc, 1000 cc, and so on, or an equivalent for electric or other drive bikes.

Further, according to some implementations, the grouping may include not just the actual style of the rider, but also their desired style. For example, a safety rating may be determined for a rider. In this case, a rider with a low rating (or another designation that identifies a poor safety rating) may nonetheless desire to ride with riders that have a high safety rating. In this way, the poorly rated rider may learn better safety habits and practices from the highly rated riders.

In some implementations, the highly safe rated rider(s) might be provided the opportunity to choose whether to accept the lower safety ranked riders that want to learn, or to only ride with other safe riders. Based on a saved preference file (e.g., user preferences), a learned preference, or a choice at the time of the decision, the linking may be denied or approved. Thus, the system might be utilized to group experienced or more skilled riders with less experienced or less skilled riders.

As an example, the profile manager 206 may obtain information about the first user and map that information to predefined settings (e.g., trip or run preferences, likes, dislikes, driving behavior, and so on). The predefined settings may have different subsets that provide granularity related to the particular setting. For example, a setting related to speed may include a subset for “drives at or below speed limit,” “drives within 10 miles above speed limit,” “speeds over ten miles above speed limit,” and other subsets. Thus, as information is observed (or manually input by the user), each user may be placed into the appropriate subset.

The settings and/or subsets may dynamically change as the user's behaviors or habits change. For example, the user may habitually speed and, therefore, this habit places the user in the speed category. Then the user's wife has a baby and the user decides to no longer be reckless and, therefore, drives within 10 miles of the speed limit. Based on this change, the user is moved from the speed category to the 10 miles category. The other users are categorized in a similar manner and, based on these categorizations, the linking component 212 makes a determination as to which users would be a good match for each other.

According to some implementations, the system 200 may include an interface component 214 that allows the first user to interact with the system 200. For example, the first user may indicate that he/she would like to be grouped with other users, even if the riding behavior settings do not match. Thus, for at least a portion of the trip or run, the first user may be grouped with another user that tends to travel faster (or slower) than the first user normally travels.

A willingness to be grouped with travelers who are open to whom they travel with may also be utilized as a preference. For example, a first traveler may be willing to travel with a faster second traveler. In this case, there might be some assumption that the first traveler will conform to the preferences of the second traveler by traveling faster. This is distinct from both travelers being willing to change from their usual system, meet in the middle, or otherwise mutually adapt their behavior to each other, which might be the case according to some implementations.

Further, the first user may interact with the interface component 214 to provide a listing of other users that he/she does not want to be grouped with. This information may be provided at any time. For example, the first user may be grouped with someone and, for various reasons the grouping does not work. Therefore, the first user may indicate that she does not want to be grouped with that person in the future. In some cases, the request not to be grouped with someone may be made in advance (e.g., based on a prior relationship between the users). In this case, even if the users would benefit from being grouped, the linking component 212 ignores the information related to the other user being around and a candidate for grouping. In some implementations, a map or other indication may include the other user, but that user may be distinguished from the other users (e.g., a warning provided, an icon of the user is indicated but a red “X” is placed over the icon of the user on the map). In this manner, the presence of the other user is known, but information or instructions related to linking with that user is not provided.

According to some implementations, the interface component 214 (as well as other interface components discussed herein) may provide a graphical user interface (GUI), a command line interface, a speech interface, Natural Language text interface, and the like. For example, a GUI may be rendered that provides a user with a region or means to load, import, select, read, and so forth, various requests and may include a region to present the results of the various requests. These regions may include known text and/or graphic regions that include dialogue boxes, static controls, drop-down-menus, list boxes, pop-up menus, as edit controls, combo boxes, radio buttons, check boxes, push buttons, graphic boxes, and so on. In addition, utilities to facilitate the information conveyance, such as vertical and/or horizontal scroll bars for navigation and toolbar buttons to determine whether a region will be viewable, may be employed. Thus, it might be inferred that the user did want the action performed.

While a touch screen is the preferred mean to make selections while riding, the user may also interact with the regions to select and provide information through various devices such as a mouse, a roller ball, a keypad, a keyboard, a pen, gestures captured with a camera, a touch screen, and/or voice activation, for example. According to an aspect, a mechanism, such as a push button or the enter key on the keyboard, may be employed subsequent to entering the information in order to initiate information conveyance. However, it is to be appreciated that the disclosed aspects are not so limited. For example, merely highlighting a check box may initiate information conveyance. In another example, a command line interface may be employed. For example, the command line interface may prompt the user for information by providing a text message, producing an audio tone, or the like. The user may then provide suitable information, such as alphanumeric input corresponding to an option provided in the interface prompt or an answer to a question posed in the prompt. It is to be appreciated that the command line interface may be employed in connection with a GUI and/or API. In addition, the command line interface may be employed in connection with hardware (e.g., video cards) and/or displays (e.g., black and white, and EGA) with limited graphic support, and/or low bandwidth communication channels. This may also be performed at the time of the ride (from the motorcycle), or offline (e.g., at computer hours before the ride).

In accordance with the present invention, the system of FIG. 2 may form a group or pack of travelers for at least a portion of a route according to an aspect of this disclosure. Various travelers may be grouped for any length of time during a trip. For example, a trip may include various route segments. The route segments may be defined based on various criteria including city blocks, highway mile markers, miles to be driven, and so on. Further, even though travelers are grouped, any of the travelers may leave the grouping as desired.

Included in the system 200 may be a route navigator that evaluates planned routes and/or inferred routes of each user of the group of users. According to an implementation, each user may interface with respective interface components to input a planned route (e.g., traveling from one state to another state and using designed highways). For example, one or more riders may enter or communicate other intermediate nodes in a route or waypoints (e.g., fuel stops, restroom breaks, meal breaks, sightseeing breaks, and so on). Each rider may individually choose to join the break together or continue separately (and perhaps meeting again later).

In an additional or alternative implementation, routes of the respective users may be determined based on observations and/or historical information (e.g., on weekdays the rider travels from her home to work, which is 40 miles away on Interstate 71). Accordingly, it may be inferred that since it is Thursday, she/he is traveling to work via Interstate 71.

Based on the planned and/or inferred route information, segments of the route may be ascertained by the route navigator. Thus, users that are sharing at least some route segments may be linked while traveling along those route segments.

The system 200 may also include a comparator or radar system that maps a location of each rider in a group or pack and compares a route of the first user with respective routes of users in the group of users. Further, alerts may be sent when one or more users in a group stray outside a predetermined radius or distance from the other members of the group or the group leader. The comparator may utilize information related to the timing of when each user of the group of users travels (or will be traveling) along a particular route segment. For example, a first user is traveling along a route segment, and a second user is just up ahead and both users have indicated they would like to group with others. Then, the first user may be instructed to speed up slightly, and the second user is instructed to slow down slightly in order for the users to join together.

According to some implementations, at least some of the route segments may be output to the user in a perceivable format, such as on a map display on a portable device or a navigation display.

Information related to a planned route, expected stops, and so on may be manually input by each user on their respective interfaces. However, in the preferred embodiment, the leader controls the travel route and waypoints for the group. In another example, information related to the route and expected stops may be inferred based on observed information, historical information, or other considerations.

According to some implementations, the users are provided information that details why the users are being grouped. In such a manner, each user may decide as to whether to accept the suggestion to group with the other user. The user may affirmatively accept the suggestion based on a prompt (e.g., “Do you want to group with User Y?”) The user may verbally approve (or disapprove) the suggestion or convey the decision in another manner (e.g., manual input, shaking head, and so on).

The various aspects (e.g., in connection with observing users and grouping groups of two or more users, and so on) may employ various artificial intelligence-based schemes for carrying out various aspects thereof. For example, a process for determining if certain users should be grouped, determining how to group users, providing instructions for the grouping, determining for which portions of a route two or more users may be grouped, and so on, may be enabled through an automatic classifier system and process.

Additionally or alternatively, an implementation scheme (e.g., a rule, a policy, and so on) may be applied to control and/or regulate the grouping of users. In some implementations, based upon a predefined criterion, the rules-based implementation may automatically and/or dynamically group users, provide a grouping suggesting, automatically output instructions for the grouping, and so on. In response thereto, the rule-based implementation may automatically interpret and carry out functions associated with the grouping by employing a predefined and/or programmed rule(s) based upon any desired criteria.

Methods that may be implemented in accordance with the disclosed subject matter will be better appreciated with reference to the following flow charts. While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g. device, system, process, component, and so forth). Additionally, it should be further appreciated that the disclosed methods are capable of being stored on an article of manufacture to facilitate transporting and transferring such methods to various devices. Those skilled in the art will understand and appreciate that the methods might alternatively be represented as a series of interrelated states or events, such as in a state diagram.

Some of the features presented by the instant invention include and interface to create and edit a trip or “run”, viewing and communicating during a run, and other safety features that might accompany the system and method of the present invention as described herein.

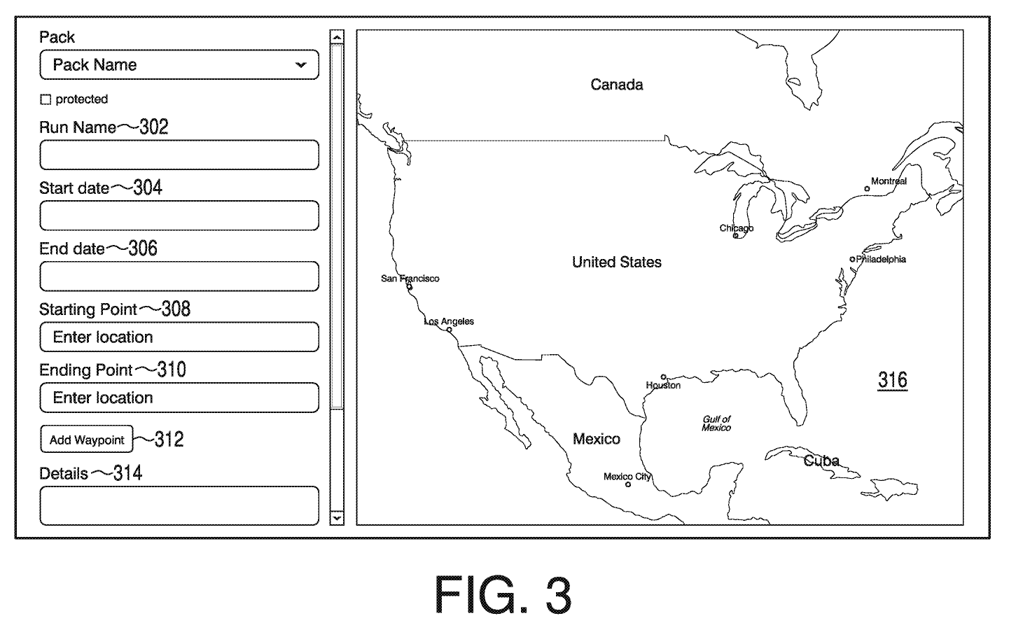

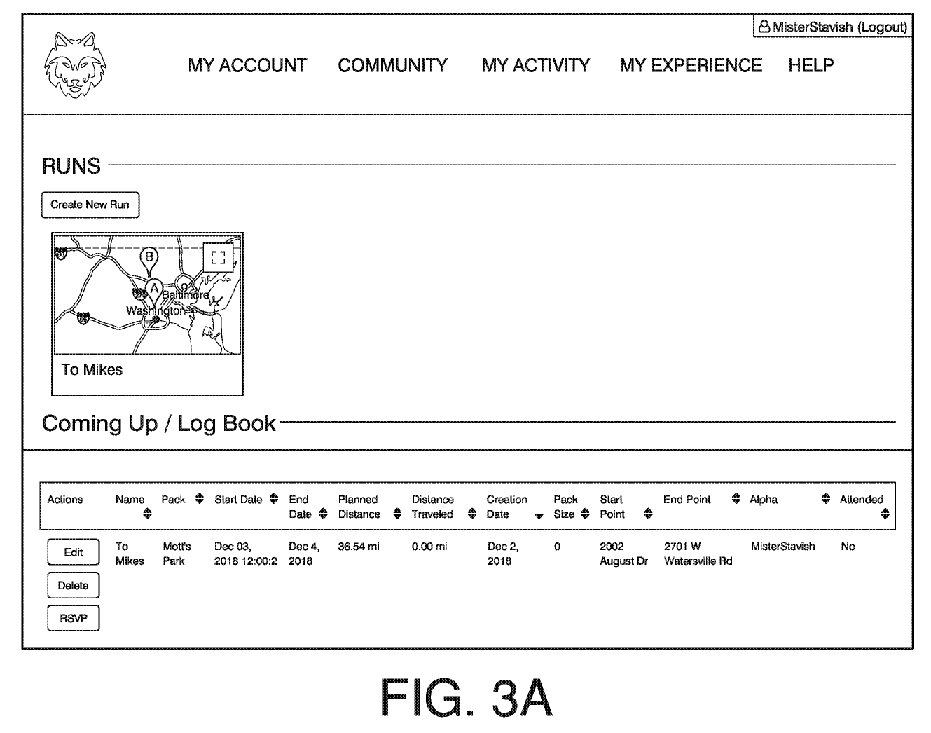

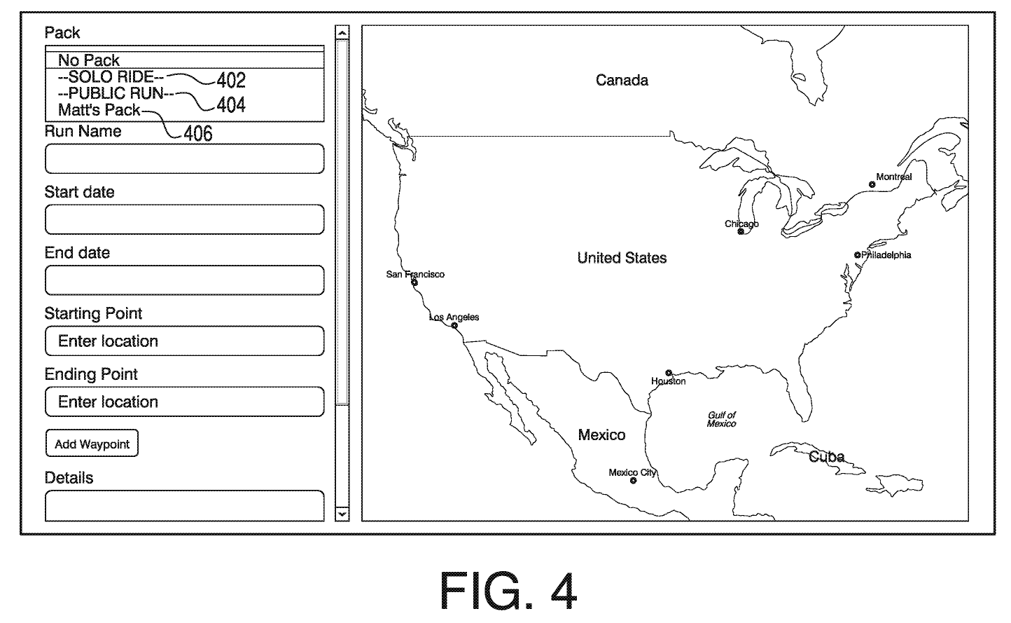

FIG. 3 illustrates an exemplary data input system for creating a new kind of run open to a closed group or open to the public. Users can search for public runs by choosing a location and a distance around that address (e.g., all public runs created within 10 miles of Sturgis, S. Dak.). With reference to FIG. 3, the leader may create a run by entering certain predetermined data associated with creating a run such as the run name 302, the start date 304, the end date 306, the start point 308, the end point 310, optional waypoint(s) 312 along with customized details 314 assigned by the leader or alpha member of the pack. A geographic map 316 may be used to display the route or routes of travel assigned by the navigation manager 210 (FIG. 2). In accordance with the invention, the leader or alpha user may choose a public run 402 or a solo run 404 if traveling solo (See FIG. 4). Alternatively, the leader may select the associated pack (e.g., “Matt's Pack”) 406 and create a new run assigning the predetermined data 302-314 discussed above.

Upon account creation, it is noted that the system may additionally provide the user with an automatically-created pack (group) if the user does not choose to first create one. This group is assigned a name and functions otherwise as any other pack in the system.

FIG. 3a illustrates an alternate interface for inputting and creating a run as described with respect to FIG. 3.

The interface shown in FIG. 3 may also include a profile view, whereby the system presents a main menu display “snapshot” of the user's profile. This snapshot is intended to provide a quick reference to details from the user's profile settings. Through this interface, a user may update their personal profile or edit application settings. The user may view their profile image, user identification code (“user ID”).

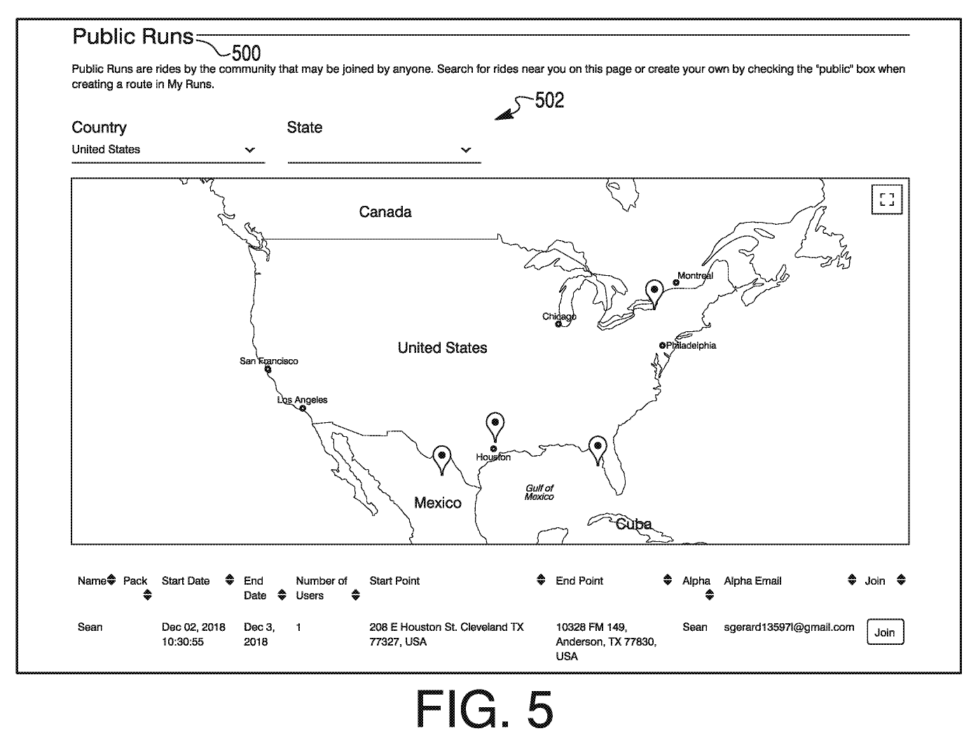

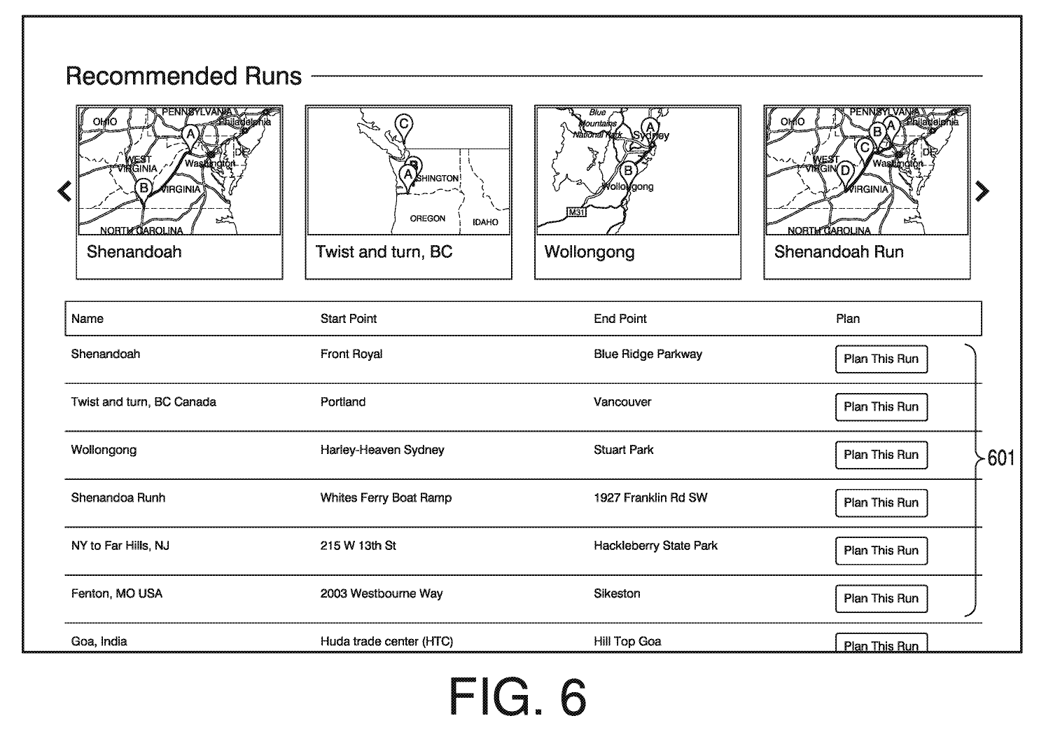

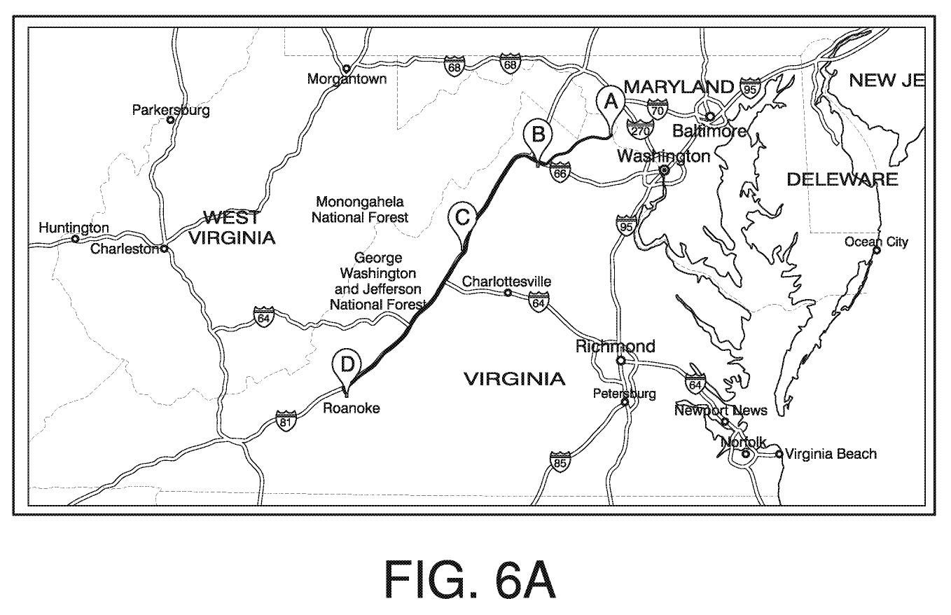

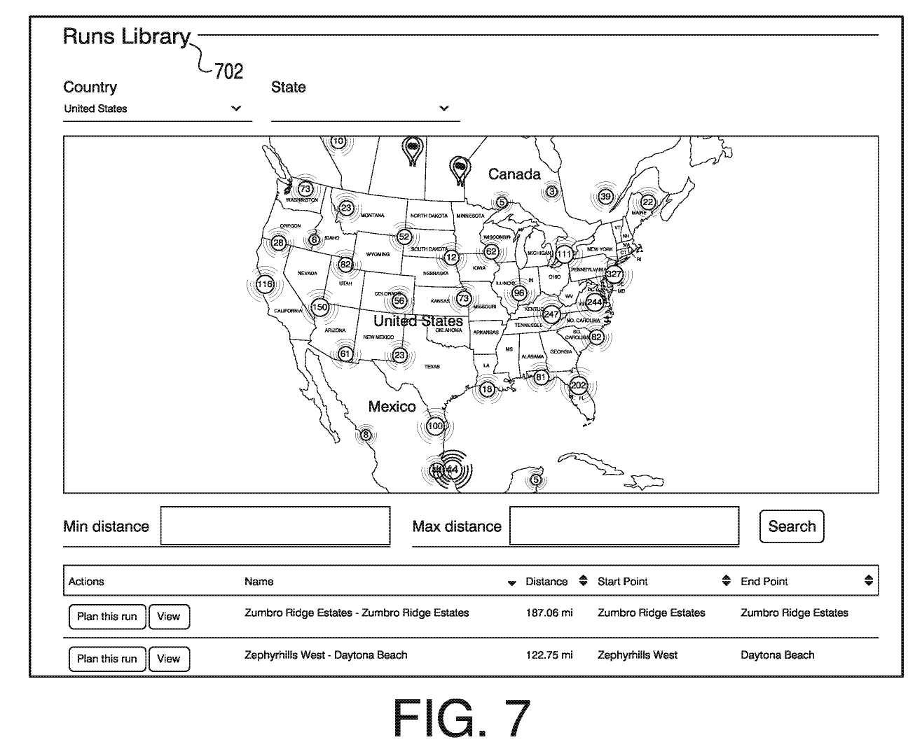

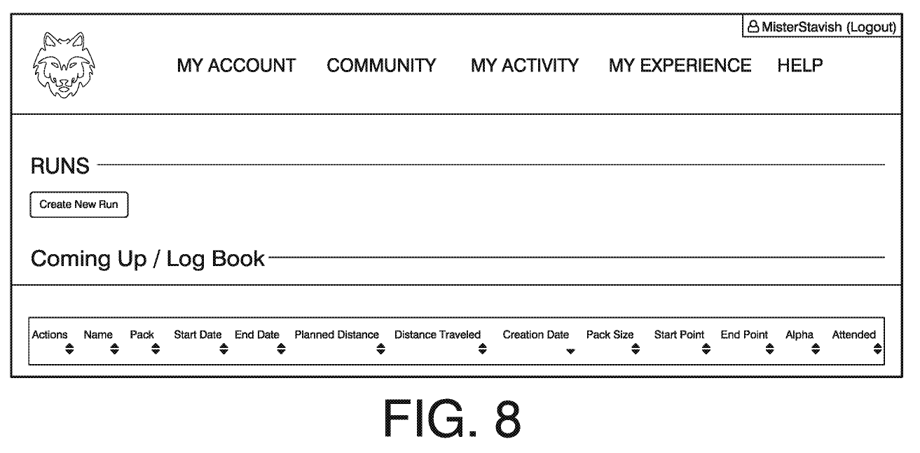

As shown in FIG. 5, a public run may be created based on location(s) 502 entered into the system or may be chosen from a menu of stored runs 601 previous created and stored by the system (see FIG. 6 and FIG. 6a). FIG. 6 illustrates a list of recommended runs 601 with an associated “map view” of some of these runs, while FIG. 6a illustrates an enlarged map view of path of travel related to one of the recommended runs stored in the system. Similarly, the user(s) may choose from a library of stored runs 702 in a runs library stored by a user or by a group that has stored a history log within the system. The system may further include a log of previous runs by a particular pack or by the society in general having access to this system as shown in FIGS. 7 and 8. FIG. 7 illustrates an exemplary non-limiting embodiment for selecting a travel route or run from a previously stored set of runs stored in a library of the system according to an aspect of this disclosure. The “run library” is an efficient and effective mechanism to store a record of previous runs which is not provided by typical traveling applications, but the run library provides a mechanism to recall and repeat previous travel routes. The traveler may add notes to the previous trip for easier recall and may recommend such routes to other travelers. These are just a few of the novel features provided by the run library as will be understood by those of skill in the art. FIG. 8 may also be used by a user to display various trip data; e.g., from the home screen, a user may view his/her lifetime activity (travel and groups) 801 including group names, dates (start and end), planned distance, historic distance traveled, group/pack size, start point, end point, etc. Moreover, the system may be used to access user profiles to view details from other users by pressing on their profile image.

The system further provides a mechanism for pack chat whereby members of a pack get a “chat room” automatically created for them so that they can send messages to fellow members from within the system. Moreover, weather forecast may be provided to see weather for start and destination points in the user's trip. The system may also provide access to different partnerships or partnership programs. For example, a roadside assistance partnership, provided by a unique volunteer program of bikers helping bikers.

A sharable unique ID code may be assigned to every pack, whereby sharing the ID code with a user may permit the user to easily join the pack by entering the code.

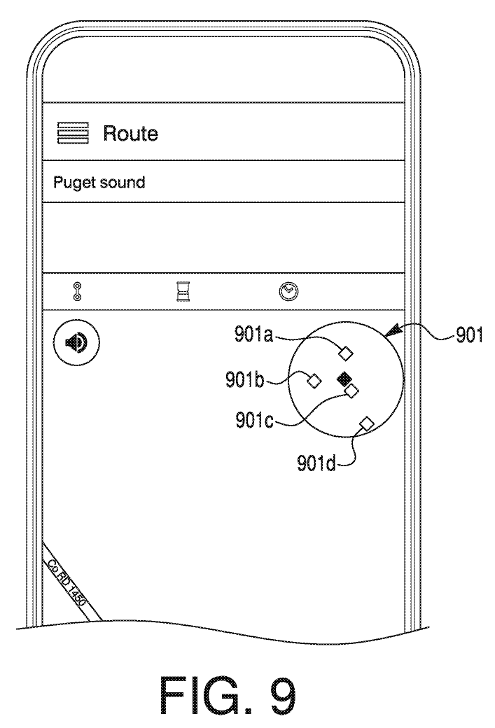

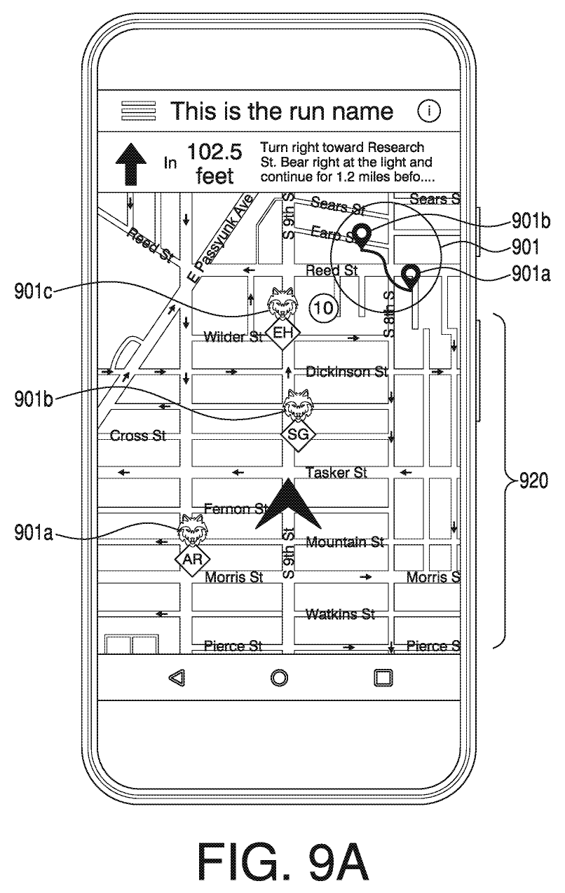

FIG. 9 illustrates an exemplary, non-limiting, embodiment for displaying a route of travel for a group whereby every rider in the pack sees the position of other riders in a display window which allows the rider to keep formation and position within the pack. As shown in FIG. 9, each traveler (e.g., rider 901a-901d) is shown relative to each other in a “radar window” 901. This feature is particularly beneficial in keeping the pack together according to an aspect of the instant disclosure. FIG. 9a illustrates an alternate embodiment showing a big radar feature whereby a traveler may switch from the view shown in FIG. 9 to an alternate view including a big radar window 920 (preferably superimposed on display or radar window 901) showing the general position of each traveler in window 901 as well as the specific coordinates (e.g. street location) of each traveler in window 920 so that travelers may locate one another to meet up or provide helpful traveling advice. The big radar window 920 provides specific identification details for each traveler (e.g., initials, logos, ID, etc.) with street locations and an active movement window (e.g., an active map display) utilizing up-to-date GPS data. By way of example, each traveler's initials are shown in FIG. 9a. In a preferred embodiment, each traveler may switch back-and-forth (toggle) between the view of FIG. 9 and the view of FIG. 9a with FIG. 9a showing a moving geofence. Notably, the moving geofence is unique to this invention in that the display window moves with the group or pack. Additionally, each traveler or rider 901a-901d may set the resolution or dimensions of the display window 901, 920 and receive notification when one or more travelers, users or riders moves outside of the geofence settings. Additionally, the features of FIG. 9 and FIG. 9a may provide turn-by-turn navigation available with both audio and video features for each user to facilitate maintain the group proximity and keeping the group together. Additionally, the features of FIG. 9a, which provide a “moving geofence” whereby every rider has a “geofence” around them that is the size of the window's resolution, provide individual viewing capabilities for each traveler, user or rider to maintain position and formation within the group. For example, if the radar view is set to 1 m, then the geofence size is 1 m around the user. Each user may have a different window resolution or “radar resolution” to witness the relative position of each traveler. To illustrate this concept, the invention of FIGS. 9 and 9a may be employed by a church or school during a field trip. Here, the lead teacher or group leader may set a display window to have a resolution or dimension of 500 yards from the lead teacher or group leaders position on the display 901. In this example, the lead teacher or group leader may receive alerts when one or more travelers within the group moves outside the moving geofence window 901, 920. This feature not only helps maintain position and formation but also improves safety and security of each traveler in the group.

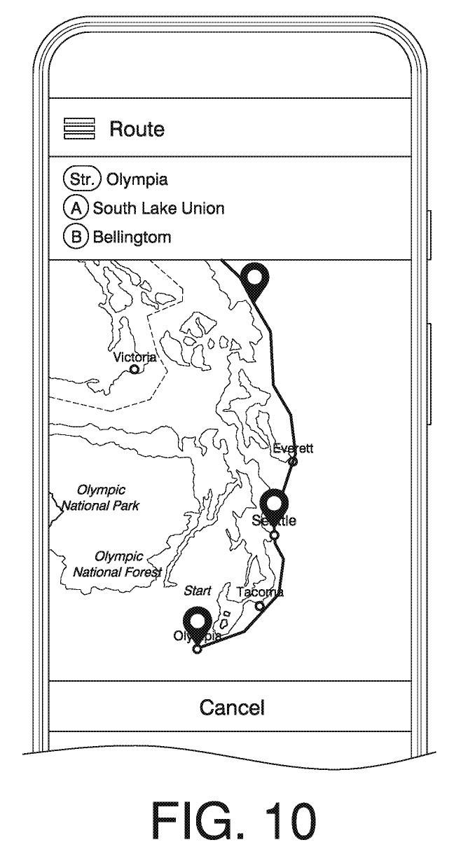

FIG. 10 illustrates an exemplary, non-limiting computing environment where one or more users may view a route of travel on a map with points of interest and waypoints are displayed in a convenient manner according to an aspect of this disclosure are implemented. FIGS. 9 and 10 illustrate the Smartphone environment for utilizing the computer-implemented aspect of the present invention.

Keeping the group of riders together is a priority of the system presented herein. Hence, the first overlay on top of a map display, e.g., Google Maps, is preferably the group's route displayed to every individual in the group that has joined a specific run as shown in FIG. 10. Each and every member of the group preferably sees the same route and navigates using the same map. The system also shows, via a radar map 901, the relative location of each rider 901a, 901b, 901c, and 901d to the other riders, using a radar feature 901, as shown in FIG. 9. Every rider in the pack sees the position of other riders (901a, 901b, 901c, 901d of FIG. 9)) allowing the rider to keep formation and position within the pack, thus keeping the pack together—while at the same time viewing the overall map showing the planned event or run in general. As the ride progresses, if gaps are opening between the riders those gaps show and riders can adjust the riding pace to match others, thus, making sure no one gets separated. In case a rider does get separated, it is indicated on the radar, allowing the pack to slow down or even track back if needed, to find the rider that got separated from the pack. The application allows the user to set the radius of the radar, thus, a user can adjust the radius to the riding stile and the size of the group that is riding together. For example, if the radius is 1 mile, if a distance between a rider and individuals in the group will go outside of that radius, the rider will be alerted that the group has parted outside a predetermined parameter. The radar radius and other parameters of the radar map 901 may be configured from the settings screen.

Thus, in the navigation mode, the system as shown in FIG. 9 provides an alternative view that shows the actual location of each group member 901a-901d, on a map, allowing to find those members, easily and quickly. Each individual appears as an icon in the location detected by the system of this invention. The icon may be easily identifiable as it may display each user's initials or other identifying feature. The underlying map is provided with configurable resolution (e.g., it may be configured to show a range of 1 mile around the user or other pre-set options). The map shows details about the user's surroundings such as street names and points of interest. FIG. 9a provides the ability to focus more directly on the specific location of each traveler in a specific group with an active map display identifying each specific traveler and their specific GPS location.

It is noted that a user may skip a waypoint (whether they missed, or just decided not to go to the way-point) and continue the ride. Again, waypoint are locations along the path of travel for the event that are added prior to the beginning of the run or added during the run by one or more of the users.

A user may add a description to a run so that those invited have more info when they are invited.

A safety feature may be included so that the user can turn on a setting to automatically re-center the map on the user's location while navigating. When turned on, this saves the user from needing to press the re-center button if they accidentally scroll away from the user's location.

The system further provides a run library, which may be a crowd-sourced collection of ideas for routes to take with a specific pack that may grow in content over time. Users can find a ride, copy it to their account, and share with their group. The system allows a user to re-travel the trip that has been captured in the run library. The trip can be re-traveled as is, or, changes may be made to it, at the user's discretion.

A mode may be employed through which a user may make themselves discoverable to other users. Other users will have the ability to request a connection, which may be accepted or denied.

A navigation mode may be employed where navigation is relative to the leader rather than a pre-planned turn-by-turn navigation route. Moreover, a cloud-based system may give tour operators the ability to improve their service offerings and monitor the experience of their customers. In short, the system may include: (1) tour route planning; (2) customer group management, (3) location tracking, and (4) chat-based support.

Support the GPX format for enhanced trip planning. GPX is a format that captures GPS-related travel information. The system would support importing such files to allow for route planning on the system. GPX is just an example for potential file formats to be imported. The system is designed to support any type of file import.

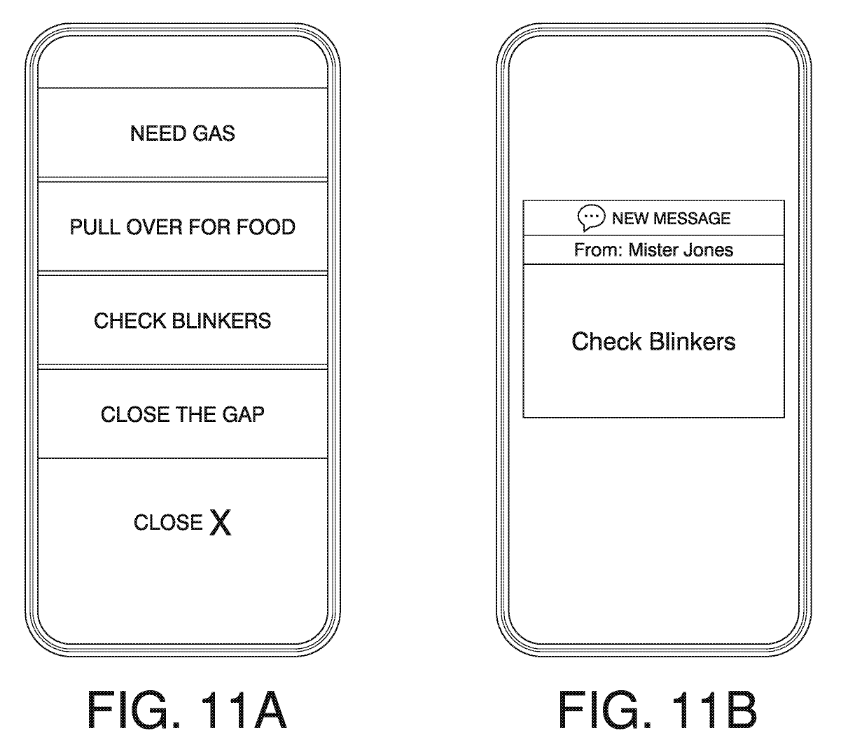

Another feature with group traveling and a source of frustration and confusion is communication. To solve that problem, the system provides a “group broadcast” messaging solution that allows pack members to communicate, while on the trip through the use of a number (e.g., four) pre-canned messages (additionally each rider can have additional custom messages). Using motorcycle riders as an example, messages can be sent with a touch motion (e.g. three “clicks”) in a safe way, with virtually no distraction to the sender. This way, once a rider sends a message, all other riders receive that immediately on their screen in a safe manner, without the need to make calls, type or send hand signals. An example of the messaging interface/messages can be seen in FIGS. 11a and 11b and may include fuel stops, food breaks, equipment notice, group dispersion, etc. to name a few. The specific messages 1101, 1102, 1103, 1104 may be customized prior to or during a specific trip then the travelers may quickly and easily send messages. For active travelers such as cyclists, motor cyclists, hikers, boaters, etc. these messages may be sent without the requirement for typing letters and words thereby avoiding a potentially dangerous situation while each traveler is actively operating a vehicle, traversing a dangerous terrain, etc.

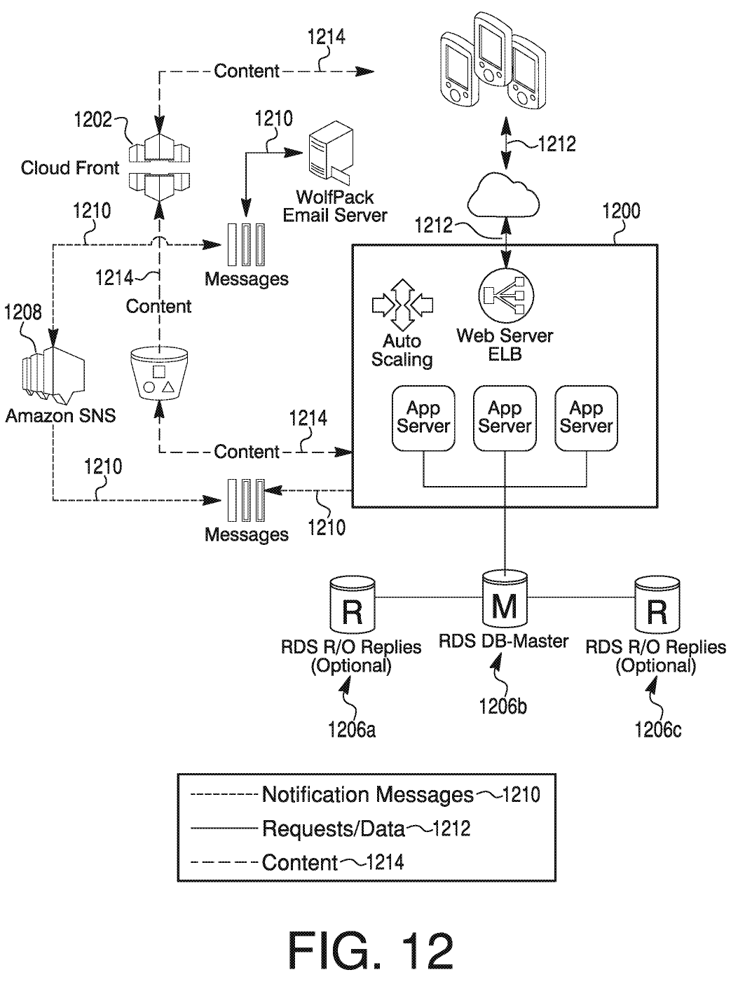

FIG. 12 illustrates one specific example of the system of the present invention. The basic components of the system shown in FIG. 12 include CloudFront 1202 which is a web service for content delivery. CloudFront makes it easier for us to distribute content to end users quickly, with low latency and high data transfer speeds. CloudFront 1202 delivers content through a worldwide network of edge locations. End users are routed to the nearest edge location, so content is delivered with the best possible performance. CloudFront 1202 works seamlessly with the storage resources, such as Amazon Simple Storage Service, which durably stores the original, definitive versions of our users' files, images etc.

S3 (Simple Storage Service) (not shown) provides the system with secure, durable, highly-scalable storage. It allows our users to store and retrieve any amount of data from anywhere on the web. RDS (Relational DB Service) 1206a, 1206b, 1206c makes it easy to set up, operate, and scale a relational database in the cloud. It provides cost-efficient and resizable capacity while managing time-consuming database management tasks, freeing us to focus on our applications and business.

Autoscaling and load balancing helps maintain application availability and allows users to scale capacity up or down automatically according to specific needs within the system 1200. The system uses auto scaling to help ensure that the system is running a desired number of server instances. Auto scaling automatically increases the number of server instances during demand spikes to maintain performance and decrease capacity during lulls to reduce costs. Auto Scaling is well suited both to applications that have stable demand patterns or that experience hourly, daily, or weekly variability in usage. Load Balancing automatically distributes incoming application traffic across multiple server instances in the cloud. It enables the system to achieve greater levels of fault tolerance in our applications, seamlessly providing the required amount of load balancing capacity needed to distribute application traffic.

SNS 1208 is a simple, fully-managed “push” messaging service that allows our users to push texts, alerts or notifications, such as a “check blinkers” message. SNS 1208 is used for sending the notifications via communication lines 1210 (notification messages line) to the different users in the system. Communication lines 1212 relate to data request and content is shown as line 1214.

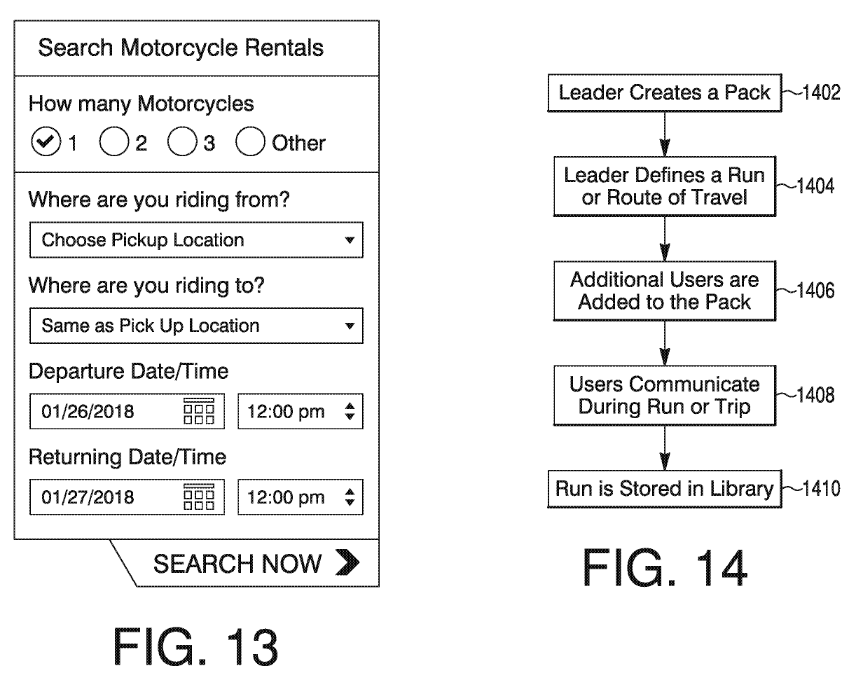

As shown in FIG. 13, the system may employ a rental feature whereby, through affiliation with a rental agency (e.g., EagleRider), users can rent a motorcycle directly through the system and in conjunction with the run details stored in the system.

FIG. 14 illustrates an example non-limiting method 1400 for grouping riders according to an aspect of this disclosure. The method 1400 may be implemented using any of the systems, such as the system 100 of FIG. 1 of the system of FIG. 12, described herein.

The method 1400 starts at 1402 when a user or leader (alpha) starts a group or pack, which is a group of users having a desire to travel within a geographic area. The group of users typically includes those users invited by the leader or having a relationship with the leader. Further, the group of users may be those users that have indicated the desire to be grouped with other riders. At 1404, the leader defines a run or route of travel for the pack. The run typically includes a start date, end date, start location and end location as described above with respect to FIG. 3. Way points may also be added to the route of travel. At 1406, respective users are added to the pack or to a specific run defined by the leader. At 1408, once the run is underway, the group may communicate with each other regarding stopping points, speed, waypoints and other relevant information associated with the specific run. At 1410, the system stores the run in a library for future use by the same group or other groups of travelers.

It is understood by way of the present invention that the geographic area may be a radius having a certain distance around the first user. In another example, the geographic area may be a certain length of a highway (e.g., 10 miles behind the first user and 10 miles ahead of the first user along a single road). In another example, the geographic area may be a generally circular area, a generally square area, a generally linear area, or areas having different shapes, contours, and lines.

Once a group of users traveling within the geographic area is determined, for example, the group of users may be evaluated for a common mode of transportation (e.g., motorcycle, vehicle, bicycle, pedestrian, and so on), the group of users will be determined which may include all the users that have previously opted into a grouping application or may only include a subset thereof.

Respective profile data of each user in the group of users may be evaluated. The system may include ranking each user based on a comparison between the respective profile data. The comparison may include how many of the settings or parameters in the respective profiles match or are substantially the same. In another example, the comparison may be based on driver preferences, wherein one or more settings or parameters are ranked higher (or weighted differently) than other parameters.

Instructions for grouping with the second user (or the selected users) may be provided. According to an implementation, the instructions may be output about the same time as the first user chooses one of the other users or approves the recommended user. The instructions may include a map that is displayed on a heads-up display, a windshield, a helmet, a user device, glasses, or on another surface that is perceivable by the first user. The map may include a location of the first user, the second user, and other users within the group of users.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

The system 1200 of FIG. 12 may include input device(s) such as keyboard, mouse, pen, voice input device, touch input device, infrared cameras, video input devices, or any other input device. Output device(s) such as one or more displays, speakers, printers, or any other output device may be included with the system. The input device(s) and the output device(s) may be connected to the system via a wired connection, wireless connection, or any combination thereof. In one or more embodiments, an input device or an output device from another computing device may be used as the input device(s) and/or the output device(s) for the system. Further, the device may include communication connection(s) to facilitate communications with one or more other devices, illustrated as a computing device coupled over a network.

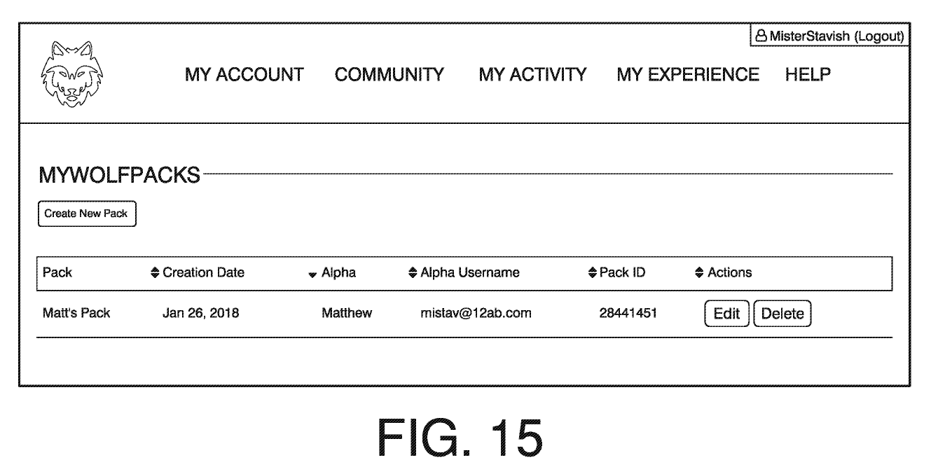

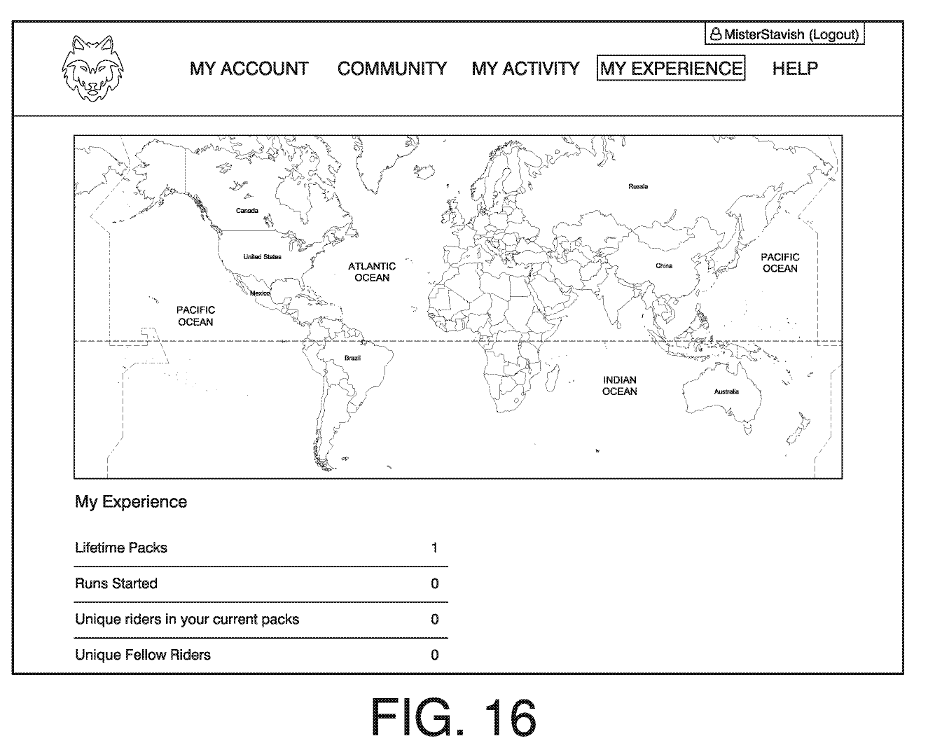

FIG. 15 illustrates a listing of previously created packs with an invitation to create new packs in accordance with an embodiment of the present invention. FIG. 16 illustrates a listing of previous experience by a particular user with specific data about historical runs associated with that user and or pack.

It is further noted that the invention may include a feature whereby the system is designed to process and, in some cases, hide or mute indications of other users' network connectivity during navigation sessions. Based on an algorithm, the system handles brief disconnections without distracting other users. Specifically, enter/leave run notifications are hidden from other users and the user's icon changes color in the radar. Based on the mentioned algorithm, longer-duration gaps in network coverage are indicated to other users such that they can identify if another rider has left the travel session intentionally or by accident.

One or more applications and/or program data may be accessible by the computing device. According to some implementations, the application(s) and/or program data are included, at least in part, in the computing device. The application(s) may include a route sharing algorithm that is arranged to perform the functions as described herein including those described with respect to the example non-limiting system 100, 200 of FIGS. 1, 2 and 12. The program data may include route sharing commands and route sharing information that may be useful for operation with allowing one or more riders to group with one or more other riders in order to travel as a group and view navigation and direction details for the group as described herein.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. A computer-implemented method of performing group navigation and group trip planning for a user, comprising:
providing to the user a computer interface constructed and arranged to receive travel criteria inputs from the user and to display human-centric navigation information to the user;
creating, by the computer interface, a planned travel route for at least one user including a start time, a starting location and an end location;
displaying on said computer interface, said planned travel route;
inviting, by the computer interface, additional users to join in a traveling event along said planned travel route, said inviting including receiving at least one additional user after said start time, said at least one additional user being able to join said traveling event after other users have embarked upon said traveling event;
communicating navigation and direction data for said traveling event between said at least one user and said additional users during said traveling event, said navigation and direction data being delivered to said at least one user and said additional users in a unified, coordinated manner;
storing travel data related to said traveling event for future access by said at least one user and said additional users.

2. The computer-implemented method according to claim 1, further comprising:
displaying, on said computer interface, a display window showing a geographic location of said user and said additional users relative to each other to indicate a range of separation between each of said user and said additional users.

3. The computer-implemented method of claim 2, further comprising:
displaying on said computer interface said planned travel route and said display window simultaneously

4. The computer-implemented method of claim 3, said displaying on said computer interface points of interest further comprising: displaying options in categories of food, lodging, transportation, arts and entertainment, camping, and businesses related to the field of endeavor.

5. The computer-implemented method according to claim 1, further comprising:
compiling a database of known planned events related to a field of endeavor in a database server computer;
receiving input data from the user identifying at least one of: a selected date and a selected location;
identifying for selection a group of planned events based on the input data received from the user, from which the user selects an identified planned event within the group from the database of known events;
planning a route to the selected event, preferring routing options favorable to meeting others interested in the field of endeavor; and displaying the planned route to the selected event.

6. The computer-implemented method of claim 1,
displaying a moving position window showing a relative position of said user and said additional users, said moving position window having a resolution set by said user to show said relative position, and
receiving an alert when any user travels beyond a predefined distance from said user.

7. The computer-implemented method of claim 1, further comprising: preparing a route plan that factors in whether additional points of interest or events can be included by judicious selection of breaks and fuel stops.

8. The computer-implemented method of claim 1 further comprising: recording in a database an indication of interest in an event by a potential attendee; and geo-locating in real time another potential attendee of the event.

9. The computer-implemented method of claim 8, wherein said geo-locating further comprising: retrieving GPS positioning information from a device identified with the other potential attendee.

10. The computer-implemented method of claim 8, wherein said geo-locating further comprising: recording in the database an indication of the location of the other potential attendee, responsive to a data input by the potential attendee; retrieving the indication of the location of the other potential attendee; and displaying to the potential attendee the location of the other potential attendee.

11. The computer-implemented method of claim 1, further comprising:
tracking and displaying locations of plural other potential attendees while they travel to the planned event.

12. The computer-implemented method of claim 1, further comprising:
tracking and displaying locations of plural other potential attendees who have indicated interest in the event.

13. The computer-implemented method of claim 1, said communicating further comprising:
sending by at least one of said user and said additional users during said travel event a pre-generated message related to equipment of a vehicle used during said traveling event and indicating a reason for at least one of said user and said at least one additional user to separate from a group of travelers defined by said user and said at least one additional user.

14. A computer program product comprising:
a computer-readable storage device; and
a computer-readable program code stored in the computer-readable storage device, the computer readable program code containing instructions executable by a processor of a computer system to implement a method for performing group navigation and planning for a user, the method comprising:
receiving travel criteria inputs from the user and to display human-centric navigation information to the user;
creating a planned travel route for at least one user including a start time, a starting location and an end location;
displaying on a computer interface said planned travel route;
inviting additional users to join in a traveling event along said planned travel route, said inviting including receiving at least one additional user after said start time, said at least one additional user being able to join said traveling event after other users have embarked upon said traveling event;
communicating between said at least one user and said additional users during said traveling event;
storing data related to said traveling event for future access by said at least one user and said additional users.
displaying, on said computer interface, a display window showing a geographic location of each said user and said additional users relative to each other to indicate a range of separation between each of said user and said additional users.

15. The computer program product of claim 14, further comprising:
displaying on said computer interface said planned travel route and said radar window simultaneously.

16. The computer program product of claim 14, further comprising:
displaying on said computer interface points of interest along the planned trip relevant to the field of endeavor and the input received from the user.

17. The computer program product of claim 14, further comprising:
sending by at least one of said user and said additional users during said travel event a pre-generated message related to equipment of a vehicle used during said traveling event and indicating a reason for at least one of said user and said at least one additional user to separate from a group of travelers defined by said user and said at least one additional user.

18. The computer program product of claim 14, further comprising:
sending by at least one of said user and said additional users during said travel event a pre-generated message related to a physical condition of at least one of said users during said traveling event and indicating a reason for at least one of said user and said at least one additional user to separate from a group of travelers defined by said user and said at least one additional user.

19. The computer program product of claim 14, further comprising:
displaying a moving position window showing a relative position of said user and said additional users, said moving position window having a resolution set by said user to show said relative position, and
receiving an alert when any user travels beyond a predefined distance from said user.

20. The computer program product of claim 14, further comprising:
sending a pre-generated message between at least one of said user and said additional users during said travel event, said pre-generated message being created prior to said traveling event and transmitted during said travel event.
